(19) United States
(12) Patent Application Publication
(10) Pub. No.: US 2025/0261088 A1
(43) Pub. Date: Aug. 14, 2025

(54) RANDOM ACCESS CHANNEL BASED REQUESTS FOR ON-DEMAND SYSTEM INFORMATION BLOCKS

(71) Applicant: QUALCOMM Incorporated, San Diego, CA (US)

(72) Inventor: Hung Dinh LY, San Diego, CA (US)

(21) Appl. No.: 18/438,071

(22) Filed: Feb. 9, 2024

(51) Int. Cl. H04W 48/14

(52) U.S. Cl. CPC H04W 48/14

(57) ABSTRACT

Methods, systems, and devices for wireless communications are described. A user equipment (UE) may apply one or more signaling methods to perform on-demand first system information block (SIB1) requests while the UE is in an idle mode. The UE may support an on-demand SIB1 procedure by an uplink wake-up signal using one or more signals. The UE may receive a configuration for performing the on-demand SIB1 requests from a network entity. The UE may transmit a first message to the network entity. The first message may indicate a request for an on-demand SIB1. In response, the UE may receive, from the network entity, a second message indicating for the UE to monitor for the on-demand SIB1. The UE may receive, from the network entity, a third message that includes the on-demand SIB1. The UE may communicate with the network entity based on information indicated in the on-demand SIB1.

### FIELD OF TECHNOLOGY

The following relates to wireless communications, including random access channel based requests for on-demand system information blocks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access channel based requests for on-demand system information blocks. For example, the described techniques provide for a user equipment (UE) that may apply one or more signaling methods to perform on-demand first system information block (SIB1) requests while the UE is in an idle (or inactive) mode. For example, the UE may support an on-demand SIB1 procedure by an uplink wake-up signal using one or more signals (e.g., using an existing signal, message, or channel). In some cases, the UE may receive a configuration for performing the on-demand SIB1 requests (e.g., via synchronization signal block (SSB) signaling, in a particular physical broadcast channel (PBCH)) from a network entity that supports on-demand SIB1 (e.g., an on-demand SIB1 cell). In some other cases, the UE may receive the configuration for performing the on-demand SIB1 requests (e.g., via SI or RRC) from a network entity that supports preconfigured (e.g., always-on) SSB and SIB1. In some examples, an on-demand SIB1 cell may operate in a same frequency or a different frequency than a network entity with preconfigured SSB and SIB1. The UE may transmit a first message (e.g., a random access channel (RACH) message) to the network entity. The first message may indicate a request for an on-demand SIB1. In response, the UE may receive, from the network entity, a second message (e.g., a second RACH message) indicating for the UE to monitor for the on-demand SIB1. The UE may receive, from the network entity, a third message that includes the on-demand SIB1. The UE may communicate with the network entity based on information indicated in the on-demand SIB1. Thus, the UE may request SIB1 messages from a network entity on demand (e.g., when the UE determines to obtain the SIB1 messages).

A method for wireless communications by a UE is described. The method may include transmitting a first message that indicates a request for an on-demand first system information block, receiving, in response to the first message and via a physical channel, a second message indicating for the UE to monitor for reception of the on-demand first system information block, receiving, based on the second message and via the physical channel, a third message that includes the on-demand first system information block, and communicating with a network entity based on the on-demand first system information block.

A UE for wireless communications is described. The UE may include one or more memories storing processor executable code, and one or more processors coupled with the one or more memories. The one or more processors may individually or collectively be operable to execute the code to cause the UE to transmit a first message that indicates a request for an on-demand first system information block, receive, in response to the first message and via a physical channel, a second message indicating for the UE to monitor for reception of the on-demand first system information block, receive, based on the second message and via the physical channel, a third message that includes the on-demand first system information block, and communicate with a network entity based on the on-demand first system information block.

Another UE for wireless communications is described. The UE may include means for transmitting a first message that indicates a request for an on-demand first system information block, means for receiving, in response to the first message and via a physical channel, a second message indicating for the UE to monitor for reception of the on-demand first system information block, means for receiving, based on the second message and via the physical channel, a third message that includes the on-demand first system information block, and means for communicating with a network entity based on the on-demand first system information block.

A non-transitory computer-readable medium storing code for wireless communications is described. The code may include instructions executable by one or more processors to transmit a first message that indicates a request for an on-demand first system information block, receive, in response to the first message and via a physical channel, a second message indicating for the UE to monitor for reception of the on-demand first system information block, receive, based on the second message and via the physical channel, a third message that includes the on-demand first system information block, and communicate with a network entity based on the on-demand first system information block.

Some examples of the method, UEs, and non-transitory computer-readable medium described herein may further include operations, features, means, or instructions for receiving signaling indicating a configuration for performing an on-demand first system information block procedure, where transmitting the first message may be based on the configuration.

In some examples of the method, UEs, and non-transitory computer-readable medium described herein, receiving the second message may include operations, features, means, or instructions for receiving a confirmation of successful reception of the request for the on-demand first system information block.

In some examples of the method, UEs, and non-transitory computer-readable medium described herein, receiving the second message may include operations, features, means, or instructions for receiving signaling that includes one or more synchronization signal block indices associated with one or more respective on-demand system information blocks, a transmission repetition periodicity for the one or more respective on-demand system information blocks, a time duration during which the UE may be to monitor one or more physical channels, information related to cell access, or any combination thereof.

In some examples of the method, UEs, and non-transitory computer-readable medium described herein, the second message may be a random access response message.

In some examples of the method, UEs, and non-transitory computer-readable medium described herein, the second message may be a downlink control information message based on a cyclic redundancy check that may be scrambled by a random access radio network temporary identifier.

In some examples of the method, UEs, and non-transitory computer-readable medium described herein, the signaling may be received in one or more fields of the downlink control information message that may be also used for a second set of signaling information.

In some examples of the method, UEs, and non-transitory computer-readable medium described herein, the signaling may be received in one or more fields of the downlink control information message that may be reserved for indicating for the UE to monitor for reception of the on-demand first system information block.

In some examples of the method, UEs, and non-transitory computer-readable medium described herein, receiving the signaling may include operations, features, means, or instructions for receiving the signaling that includes one or more synchronization signal block indices associated with one or more respective on-demand synchronization signal blocks, a transmission repetition periodicity for the one or more respective on-demand synchronization signal blocks, or any combination thereof.

In some examples of the method, UEs, and non-transitory computer-readable medium described herein, communicating with the network entity may include operations, features, means, or instructions for transitioning from an idle state to a radio resource control connected state.

In some examples of the method, UEs, and non-transitory computer-readable medium described herein, the first message further indicates a request for an on-demand synchronization signal.

Some examples of the method, UEs, and non-transitory computer-readable medium described herein may further include operations, features, means, or instructions for receiving signaling indicating a configuration for a set of multiple monitoring occasions associated with receiving a set of preconfigured synchronization signals, where time resources for receiving the on-demand synchronization signal may be non-overlapping with the set of multiple monitoring occasions.

In some examples of the method, UEs, and non-transitory computer-readable medium described herein, transmitting the first message may include operations, features, means, or instructions for transmitting the first message via a physical random access channel, a physical uplink shared channel, or a physical uplink control channel.

In some examples of the method, UEs, and non-transitory computer-readable medium described herein, the first message and the second message may be random access channel messages in a random access channel procedure.

In some examples of the method, UEs, and non-transitory computer-readable medium described herein, the physical channel may be a physical downlink shared channel or a physical downlink control channel.

A method for wireless communications by a network entity is described. The method may include obtaining, from a UE, a first message that indicates a request for an on-demand first system information block, outputting, in response to the first message and via a physical channel, a second message indicating for the UE to monitor for reception of the on-demand first system information block, outputting, based on the second message and via the physical channel, a third message that includes the on-demand first system information block, and communicating with the UE based on the on-demand first system information block.

A network entity for wireless communications is described. The network entity may include one or more memories storing processor executable code, and one or more processors coupled with the one or more memories. The one or more processors may individually or collectively be operable to execute the code to cause the network entity to obtain, from a UE, a first message that indicates a request for an on-demand first system information block, output, in response to the first message and via a physical channel, a second message indicating for the UE to monitor for reception of the on-demand first system information block, output, based on the second message and via the physical channel, a third message that includes the on-demand first system information block, and communicate with the UE based on the on-demand first system information block.

Another network entity for wireless communications is described. The network entity may include means for obtaining, from a UE, a first message that indicates a request for an on-demand first system information block, means for outputting, in response to the first message and via a physical channel, a second message indicating for the UE to monitor for reception of the on-demand first system information block, means for outputting, based on the second message and via the physical channel, a third message that includes the on-demand first system information block, and means for communicating with the UE based on the on-demand first system information block.

A non-transitory computer-readable medium storing code for wireless communications is described. The code may include instructions executable by one or more processors to obtain, from a UE, a first message that indicates a request for an on-demand first system information block, output, in response to the first message and via a physical channel, a second message indicating for the UE to monitor for reception of the on-demand first system information block, output, based on the second message and via the physical channel, a third message that includes the on-demand first system information block, and communicate with the UE based on the on-demand first system information block.

Some examples of the method, network entities, and non-transitory computer-readable medium described herein may further include operations, features, means, or instructions for outputting signaling indicating a configuration for performing an on-demand first system information block procedure, where obtaining the first message may be based on the configuration.

In some examples of the method, network entities, and non-transitory computer-readable medium described herein, outputting the second message may include operations, features, means, or instructions for outputting a confirmation of successful reception of the request for the on-demand first system information block.

In some examples of the method, network entities, and non-transitory computer-readable medium described herein, outputting the second message may include operations, features, means, or instructions for outputting signaling that includes one or more synchronization signal block indices associated with one or more respective on-demand system information blocks, a transmission repetition periodicity for the one or more respective on-demand system information blocks, a time duration during which the UE may be to monitor one or more physical channels, information related to cell access, or any combination thereof.

In some examples of the method, network entities, and non-transitory computer-readable medium described herein, the second message may be a random access response message.

In some examples of the method, network entities, and non-transitory computer-readable medium described herein, the second message may be a downlink control information message based on a cyclic redundancy check that may be scrambled by a random access radio network temporary identifier.

In some examples of the method, network entities, and non-transitory computer-readable medium described herein, the signaling may be output in one or more fields of the downlink control information message that may be also used for a second set of signaling information.

In some examples of the method, network entities, and non-transitory computer-readable medium described herein, the signaling may be output in one or more fields of the downlink control information message that may be reserved for indicating for the UE to monitor for reception of the on-demand first system information block.

In some examples of the method, network entities, and non-transitory computer-readable medium described herein, outputting the signaling may include operations, features, means, or instructions for outputting the signaling that includes one or more synchronization signal block indices associated with one or more respective on-demand synchronization signal blocks, a transmission repetition periodicity for the one or more respective on-demand synchronization signal blocks, or any combination thereof.

In some examples of the method, network entities, and non-transitory computer-readable medium described herein, communicating with the UE may include operations, features, means, or instructions for transitioning from an idle state to a radio resource control connected state.

In some examples of the method, network entities, and non-transitory computer-readable medium described herein, the first message further indicates a request for an on-demand synchronization signal.

Some examples of the method, network entities, and non-transitory computer-readable medium described herein may further include operations, features, means, or instructions for outputting signaling indicating a configuration for a set of multiple monitoring occasions associated with receiving a set of preconfigured synchronization signals, where time resources for receiving the on-demand synchronization signal may be non-overlapping with the set of multiple monitoring occasions.

In some examples of the method, network entities, and non-transitory computer-readable medium described herein, obtaining the first message may include operations, features, means, or instructions for obtaining the first message via a physical random access channel, a physical uplink shared channel, or a physical uplink control channel.

In some examples of the method, network entities, and non-transitory computer-readable medium described herein, the first message and the second message may be random access channel messages in a random access channel procedure.

In some examples of the method, network entities, and non-transitory computer-readable medium described herein, the physical channel may be a physical downlink shared channel or a physical downlink control channel.

### BRIEF DESCRIPTION OF THE DRAWINGS

FIG. 1 shows an example of a wireless communications system that supports random access channel based requests for on-demand system information blocks in accordance with one or more aspects of the present disclosure.

FIG. 2 shows an example of a wireless communications system that supports random access channel based requests for on-demand system information blocks in accordance with one or more aspects of the present disclosure.

FIG. 3 shows an example of a process flow that supports random access channel based requests for on-demand system information blocks in accordance with one or more aspects of the present disclosure.

FIGS. 4 and 5 show block diagrams of devices that support random access channel based requests for on-demand system information blocks in accordance with one or more aspects of the present disclosure.

FIG. 6 shows a block diagram of a communications manager that supports random access channel based requests for on-demand system information blocks in accordance with one or more aspects of the present disclosure.

FIG. 7 shows a diagram of a system including a device that supports random access channel based requests for on-demand system information blocks in accordance with one or more aspects of the present disclosure.

FIGS. 8 and 9 show block diagrams of devices that support random access channel based requests for on-demand system information blocks in accordance with one or more aspects of the present disclosure.

FIG. 10 shows a block diagram of a communications manager that supports random access channel based requests for on-demand system information blocks in accordance with one or more aspects of the present disclosure.

FIG. 11 shows a diagram of a system including a device that supports random access channel based requests for on-demand system information blocks in accordance with one or more aspects of the present disclosure.

FIGS. 12 through 16 show flowcharts illustrating methods that support random access channel based requests for on-demand system information blocks in accordance with one or more aspects of the present disclosure.

### DETAILED DESCRIPTION

In some wireless communications systems, a user equipment (UE) may use information included in a first system information block (SIB1) for communication with a network entity. The network entity may transmit the SIB1 to the UE for identifying one or more cells that the UE may access. Additionally, the network entity may be configured to transmit synchronization signaling or system information signaling within a cell based on a configured periodicity, regardless of if there are any UEs within the cell that are capable of or in need of receiving these signals. This may result in inefficient use of network energy.

Techniques described herein support a UE that may apply one or more signaling methods to perform on-demand SIB1 requests while the UE is in an idle mode or an inactive mode (e.g., RRC inactive mode). For example, the UE may support an on-demand SIB1 procedure by an uplink wake-up signal using one or more signals. In some cases, the UE may receive a configuration for performing the on-demand SIB1 requests (e.g., via an on-demand synchronization signal block (SSB), an “always on” SSB, or an “always on” SIB1) from a network entity. The UE may transmit a first message (e.g., a random access channel (RACH) message or another message via a physical channel) to the network entity. The first message may indicate a request for an on-demand SIB1. In response, the UE may receive, from the network entity, a second message indicating for the UE to monitor for the on-demand SIB1. The UE may receive, from the network entity, a third message that includes the on-demand SIB1. The UE may communicate with the network entity based on information indicated in the on-demand SIB1. Thus, the UE may request SIB1 messages from a network entity on demand (e.g., when the UE determines to obtain the SIB1 messages), resulting in more efficient use of network energy, reduced latency, among other technical advantages. These and other techniques are described in further detail with respect to the figures.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to random access channel based requests for on-demand system information blocks.

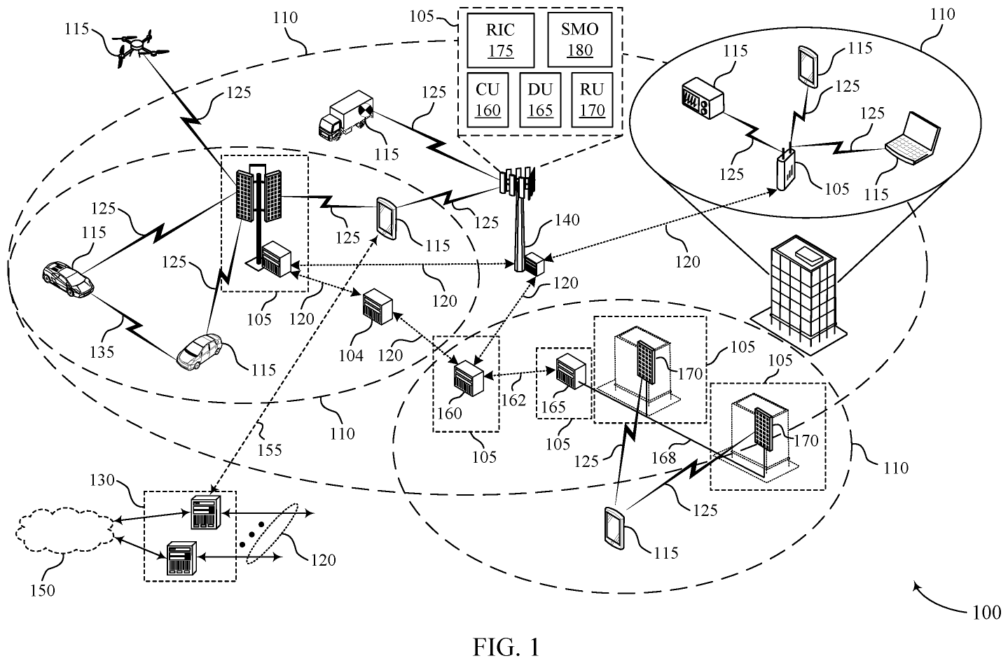

FIG. 1 shows an example of a wireless communications system 100 that supports random access channel based requests for on-demand system information blocks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may support signaling using one or more frequency ranges and applying one or more multiplexing patterns. Each multiplexing pattern of the one or more multiplexing patterns may include transmitting, at a network entity, an SSB (or a physical broadcast channel (PBCH) block), a physical downlink control channel (PDCCH) block, a physical downlink shared channel (PDSCH) block, or any combination thereof. In some cases, the network entity may transmit the PDCCH block via a set of time-frequency resources (e.g., a control-resource set, or a CORESET). The network entity may transmit a set of signals using a first frequency range that supports a first multiplexing pattern. For example, the first multiplexing pattern may include transmitting an SSB before transmitting a PDCCH block (e.g., a CORESET block) and a PDSCH block. In some cases, the network entity may transmit a SIB1 via PDSCH (e.g., in at least a portion of the PDSCH block). A given SIB1 (or a remaining minimum system information (RMSI)) may be associated with a respective SSB.

The network entity may transmit a set of signals using a second frequency range that supports a second multiplexing pattern. The second frequency range may be larger than the first frequency range. In some cases, the second multiplexing pattern may include transmitting an SSB at a transmission occasion which overlaps with a transmission occasion for a PDCCH block and a PDSCH block (e.g., the network entity may transmit the SSB simultaneously with the PDCCH block and the PDSCH block). The second frequency range may be sufficiently large such that the network entity may transmit the SSB over a first subset of frequencies and may transmit the PDCCH block and the PDSCH block over a second subset of frequencies. The network entity may be unable to support the second multiplexing pattern using the first frequency range.

In some wireless communications systems, a network entity may transmit a SIB1 according to a variable (or a default) transmission repetition periodicity (e.g., every 160 milliseconds or within 160 milliseconds). The first multiplexing pattern may correspond to a SIB1 repetition periodicity (e.g., a default repetition periodicity) at a configured value (e.g., 20 milliseconds). In the second multiplexing pattern, a SIB1 repetition periodicity may have a value equal to an SSB periodicity.

Techniques described herein support a UE that may apply one or more signaling methods to perform on-demand SIB1 requests while the UE is in an idle (or inactive) mode. For example, the UE may support an on-demand SIB1 procedure by an uplink wake-up signal using one or more signals (e.g., using an existing signal, message, or channel). That is, in some examples, the UE may leverage existing signaling mechanisms (e.g., signaling used for random access procedures) to request on-demand signaling, such as on-demand SIB1 messages and/or on-demand SSB signaling. In some cases, the UE may receive a configuration for performing the on-demand SIB1 requests (e.g., via an on-demand SSB, an “always on” SSB, or an “always on” SIB1) from a network entity. The UE may transmit a first message (e.g., a RACH message) to the network entity. The first message may indicate a request for an on-demand SIB1. In response, the UE may receive, from the network entity, a second message (e.g., a second RACH message) indicating for the UE to monitor for the on-demand SIB1. The UE may receive, from the network entity, a third message that includes the on-demand SIB1. The UE may communicate with the network entity based on information indicated in the on-demand SIB1. Thus, the UE may request SIB1 messages from a network entity on demand (e.g., when the UE determines to obtain the SIB1 messages), resulting in more efficient use of network energy. These and other techniques are described in further detail with respect to the figures.

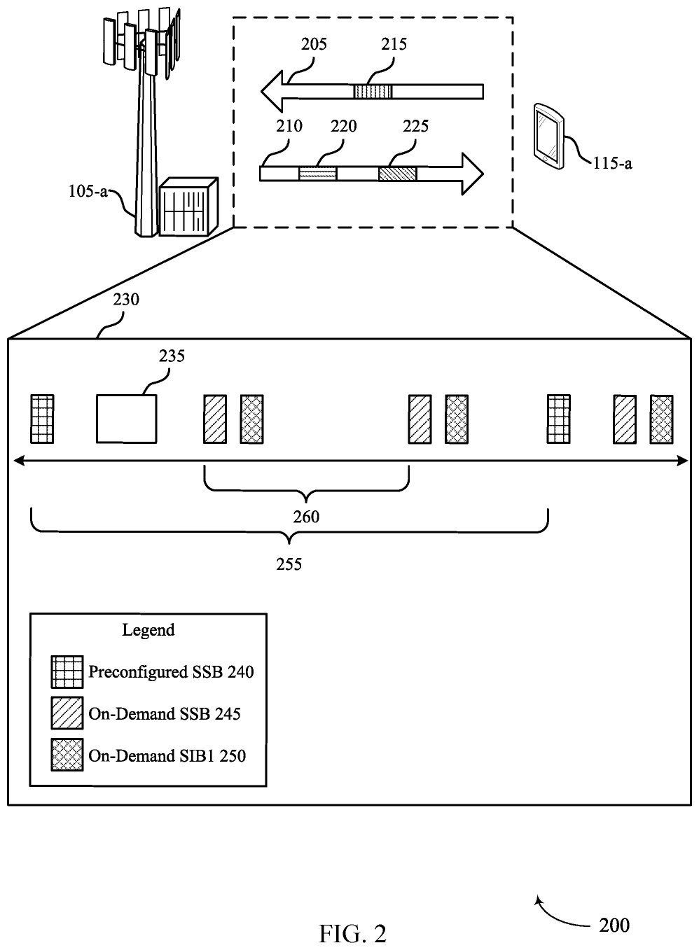

FIG. 2 shows an example of a wireless communications system 200 that supports random access channel based requests for on-demand system information blocks in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein. The UE 115-a may transmit, to the network entity 105-a, one or more messages via an uplink connection 205. The UE 115-a may receive, from the network entity 105-a, one or more messages via a downlink connection 210. The uplink connection 205 and the downlink connection 210 may be respective examples of physical channels (e.g., PDCCH, PDSCH, physical uplink control channel (PUCCH), physical uplink shared channel (PUSCH), or the like). In the following description, although procedures may refer to transmitting or receiving an on-demand SIB1 250, the procedures may also be applied for transmitting or receiving an on-demand SSB 245.

In some implementations, the UE 115-a may receive a configuration (e.g., a RACH configuration) for performing an on-demand SIB1 procedure. For example, the UE 115-a may receive the configuration from the network entity 105-a, from another cell (e.g., a cell which is separate from the network entity 105-a), or both. The UE 115-a may receive the configuration in an SSB (e.g., a preconfigured SSB 240 from the network entity 105-a).

In some cases, the UE 115-a may transmit a request message 215 via the uplink connection 205 based on the configuration. The request message 215 may include a request for an on-demand SIB1 250, an on-demand SSB 245, or both, from a cell that supports on-demand SIB1 250, on-demand SSB 245, or both. The request message 215 may be an example of a RACH message (e.g., a first message (Msg1), a MsgA, or a third message (Msg3) of a RACH procedure), or may be an example of another type of uplink messaging sent via a physical channel. An occasion for the request message 215 may be a shared occasion (e.g., shared with one or more other RACH messages) or may be a separate occasion (e.g., reserved for the SIB1 or SSB request). For example, the UE 115-a may transmit the request message 215 as part of a RACH procedure (e.g., for initial access of a cell). After transmitting the request message 215, the UE 115-a may begin monitoring for a confirmation message 220.

In some cases, if the request message 215 is an example of or is included in a first message of a RACH procedure (e.g., Msg1), the UE 115-a may transmit the request message 215 via a physical random access channel (PRACH). In some other cases, if the request message 215 is an example of or is included in a third message of a four-step RACH procedure (e.g., Msg3) or a first message of a two-step RACH procedure (MsgA), the UE 115-a may transmit the request message 215 via PRACH, PUSCH, or both.

In some examples, after successfully receiving the request message 215, the network entity 105-a may transmit the confirmation message 220 to the UE 115-a via the downlink connection 210 (e.g., a physical channel). The confirmation message 220 may be an example of a physical RACH message (e.g., a second message (Msg2), a MsgB, or a fourth message (Msg4) of a RACH procedure). In some cases, the confirmation message 220 may be an example of a monitoring message. For example, the confirmation message 220 may indicate for the UE 115-a to monitor for an information message 225 (e.g., including an on-demand SIB1 250 or an on-demand SSB 245). If the network entity 105-a does not receive the request message 215, the network entity 105-a may refrain from transmitting the confirmation message 220, the information message 225, or both. The confirmation message 220 may allow the UE 115-a to monitor for the information message 225 when the network entity 105-a is to transmit the information message 225, resulting in relatively low access latency and reduced power consumption at the UE 115-a. In some cases, if the confirmation message 220 is an example of or is included in a second message (e.g., Msg2) or a fourth message (e.g., Msg4) of a RACH procedure, the UE 115-a may receive the confirmation message 220 via PDSCH. In some cases, the UE may receive the confirmation message 220 via PDCCH. If the confirmation message 220 is an example of or is included in a second message (e.g., MsgB) of a two-step RACH procedure, the UE 115-a may receive the confirmation message 220 via PDSCH, PDCCH, or both.

In some cases, after receiving the confirmation message 220, the UE 115-a may monitor for the information message 225. The UE 115-a may receive the information message 225 via the downlink connection 210. The information message 225 may include an on-demand SSB 245, an on-demand SIB1 250, or both. Thus, the information message 225 may be an example of an on-demand information message.

The network entity 105-a and the UE 115-a may perform signaling according to a timing diagram 230. For example, the UE may receive one or more preconfigured SSBs 240 (e.g., sparse “always on” SSBs), one or more on-demand SSBs 245, and one or more on-demand SIB1s 250. The UE 115-a may perform a wakeup signal procedure 235, which may include detecting a wakeup trigger (e.g., a signal from the network entity 105-a or an internal signal) and transmitting one or more signals indicating a transition from an idle state to an active state at the UE 115-a. In some cases, the UE 115-a may receive the one or more preconfigured SSBs 240 in accordance with a first periodicity 255. Additionally or alternatively, the UE 115-a may receive the one or more on-demand SSBs 245, the one or more on-demand SIB1s 250, or both, in accordance with a second periodicity 260. In some examples, the first periodicity 255 may be greater than or less than the second periodicity 260 (e.g., the UE 115-a may receive the preconfigured SSBs 240 less frequently than the on-demand SSBs 245 and the on-demand SIB1s 250) according to one or more request messages 215 from the UE 115-a.

In some implementations, the network entity 105-a and the UE 115-a may individually or collectively perform a signaling procedure using a RACH procedure (e.g., a 4-step RACH procedure). The signaling procedure may be an example of an on-demand SIB1 procedure or an other system information (OSI) procedure. For example, the OSI may include system information other than SIB1 (e.g., SIB2, SIB3, and so on). In some cases, if dedicated RACH occasions of the RACH procedure are configured, the signaling procedure may be based on contention free random access (CFRA). For example, the UE 115-a may transmit, to the network entity 105-a, a first message of the RACH procedure (e.g., The request message 215 may be a Msg1) including a request for an on-demand SIB1. The network entity 105-a may transmit, to the UE 115-a, a second message of the RACH procedure (e.g., the confirmation message 220 may be a Msg2). The second message of the RACH procedure may be an example of a random access response (RAR) and may include at least a random access preamble identifier (RAPID), which may depend on or may be based on an index for a random access preamble (e.g., the Msg1 of the RACH) and time/frequency resources where PRACH (carrying Msg1) is transmitted. The RAR may be included in (e.g., may be a part of) a second message of the RACH procedure (e.g., Msg2).

In some cases, if dedicated RACH occasions of the RACH procedure are not configured, the signaling procedure may be based on contention based random access (CBRA). For example, the UE 115-a may transmit, to the network entity 105-a, a third message of the RACH procedure (e.g., The request message 215 may be a Msg3) including a request for an on-demand SIB1 (e.g., RRCSib1Request). The network entity 105-a may transmit, to the UE 115-a, a fourth message of the RACH procedure (e.g., the confirmation message 220 may be a Msg4). After receiving the second message of the RACH procedure, the fourth message of the RACH procedure, or any combination thereof, the UE 115-a may receive the information message 225 (e.g., including the on-demand SIB1) from the network entity 105-a and may communicate with the network entity 105-a based on the information message 225.

In some implementations, the RACH procedure may be an example of a 2-step RACH procedure (e.g., a type-2 RACH procedure). For example, the UE 115-a may receive, in an SSB, in an RRC message, or any combination thereof, a RACH configuration from the network entity 105-a. The UE 115-a may transmit a first message of the RACH procedure (e.g., msgA, including a preamble via PRACH and a payload via PUSCH). The first message may include or may be an example of the request message 215 (e.g., the request message 215 may be transmitted in the PRACH or in the PUSCH of msgA). The network entity 105-a may decode the payload of the first message and may transmit, to the UE 115-a, a second message (e.g., msgB). For example, the UE 115-a may receive a first portion of the second message via PDCCH (e.g., a cell radio network temporary identifier (C-RNTI) or a msgB RNTI). The UE 115-a may receive a second portion of the second message via PDSCH (e.g., a success RAR). In some cases, the second message may include or may be an example of the confirmation message 220. In some implementations, the UE 115-a may verify that the UE 115-a has a valid tracking area, a valid PUCCH resource and timing, or any combination thereof, and may transmit one or more PUCCH messages (e.g., including a hybrid automatic repeat request (HARQ) acknowledgement or negative acknowledgement) to the network entity 105-a. In some cases, the msgB may have an associated window length less than or equal to a configured value (e.g., 40 milliseconds). After receiving the second message, the UE 115-a may receive the information message 225 from the network entity 105-a.

In some implementations, the network entity 105-a may transmit a set of SSBs (e.g., a set of on-demand SSBs 245) to the UE 115-a. Each SSB of the set of SSBs may be associated with a SIB1 (e.g., an on-demand SIB1 250). In some cases, a particular SSB of the set of SSBs may not be associated with any SIB1. The network entity 105-a may transmit an SSB and may refrain from transmitting a SIB1 associated with the SSB. For example, the network entity 105-a may transmit the set of SSBs and may transmit a subset of associated SIB1 messages.

In some cases, the network entity 105-a may transmit, to the UE 115-a, a set of system information in one or more messages (e.g., in the confirmation message 220, in the information message 225, or both). The set of system information may include a set of SSB indices (e.g., as a bitmap) that have respective associated on-demand SIB1s 250. The UE 115-a may monitor PDCCH including DCI with grant that schedules PDSCH carrying SIB1 (e.g., the PDCCH may be referred to as a SIB1 PDCCH) according to the set of SSB indices, reducing the UE's SIB1 PDCCH search and access latency. Additionally or alternatively, the set of system information may include an indication of a duration in which the UE is to monitor SIB1 PDCCH, an indication of a SIB1 transmission repetition periodicity (e.g., the second periodicity 260), or both. The indicated SIB1 transmission repetition periodicity may override a default SIB1 transmission repetition periodicity. In some examples, the UE 115-a may receive the SIB1 via PDSCH. In some cases, the set of system information may include cell access related information. For example, the cell access related information may include cell barring information (e.g., information indicating that a cell is barred from access), cell reservation information (e.g., information indicating that a cell is reserved for future use), or both. Thus, the network entity 105-a may offload some access related information from a SIB1 to the one or more messages carrying the set of system information. In some examples, the UE 115-a may refrain from monitoring for or receiving a SIB1 PDCCH or PDSCH if a cell is barred or reserved. The UE 115-a may refrain from re-transmitting the request message 215 (e.g., the SIB1 request) if the cell is barred or reserved.

In some implementations, the network entity 105-a may transmit a downlink control information (DCI) message (e.g., The DCI message may have a DCI format 1_0 with cyclic redundancy check (CRC) scrambled by random access RNTI (RA-RNTI) or msgB RNTI) to the UE 115-a. The network entity 105-a may transmit the DCI message via multiple downlink transmissions. The DCI message may include scheduling information, network information, device information, or any combination thereof. For example, the DCI message may include one or more of a frequency domain resource assignment, a time domain resource assignment, a virtual resource block to physical resource block mapping, a modulation and coding scheme, a transport block scaling, least significant bits of a system frame number, one or more bits reserved for operation in a cell with or without shared spectrum access, or any combination thereof.

In some implementations, the confirmation message 220 may be a portion of a second message of a RACH (e.g., a Msg2 or a RAR) transmitted via PDCCH in accordance with the scheduling information in the DCI message. However, in some cases, the network entity 105-a may not transmit a RAR. In such cases, the scheduling information in the DCI message may be unused by the UE 115-a. The network entity 105-a may use one or more fields of the DCI message to transmit the set of system information to the UE 115-a. For example, the network entity 105-a may transmit the set of system information by repurposing one or more fields in the DCI message (e.g., having DCI format 1_0 with CRC scrambled by RA-RNTI). Thus, the system information may be carried in fields of the DCI which may also be used for other information. Additionally or alternatively, the network entity 105-a may transmit the set of system information by introducing one or more new fields in the DCI message. Thus, the system information may be carried in fields of the DCI which may be reserved for the system information. Such techniques may be similarly applied if the confirmation message is transmitted as a portion of a fourth message of a RACH procedure (e.g., a Msg4) via PDCCH. For example, the network entity 105-a may transmit the system information in fields of a second DCI message (e.g., having DCI format 1_0 with CRC scrambled by temporary cell RNTI (TC-RNTI)).

In some implementations, the network entity 105-a may transmit a set of preconfigured SSBs 240 (e.g., “always on” or “sparse” SSBs) to the UE 115-a. Each preconfigured SSB 240 of the set of preconfigured SSBs 240 may be associated with an on-demand SSB 245, an on-demand SIB1 250, or both. In some cases, a particular preconfigured SSB 240 of the set of preconfigured SSBs 240 may not be associated with any on-demand SSB 245, on-demand SIB1, or both. The network entity 105-a may transmit a preconfigured SSB 240 and may refrain from transmitting on-demand SIB1s 250 or on-demand SSBs 245 associated with the preconfigured SSB 240. For example, the network entity 105-a may transmit the set of preconfigured SSBs 240 and may transmit a subset of associated on-demand SIB1s 250, associated on-demand SSBs 245, or both.

In some cases, the network entity 105-a may transmit, to the UE 115-a, a set of system information in one or more messages (e.g., in the confirmation message 220, in the information message 225, or both). The set of system information may include a set of SSB indices (e.g., as a bitmap) that have respective associated on-demand SIB1s 250, associated on-demand SSBs, or both. The UE 115-a may monitor for a set of one or more on-demand SIB1s 250, a set of one or more on-demand SSBs 245, or both, based on the set of SSB indices. Additionally or alternatively, the set of system information may include an indication of a SIB1 transmission repetition periodicity, an on-demand SSB transmission periodicity, or both (e.g., the second periodicity 260). The indicated periodicities may override default SIB1 or SSB transmission periodicity. In some cases, the set of system information may include cell access related information. For example, the cell access related information may include cell barring information, cell reservation information, or both. In some examples, the UE 115-a may refrain from re-transmitting the request message 215 and from monitoring for or receiving a SIB1 PDCCH or PDSCH if a cell is barred or reserved.

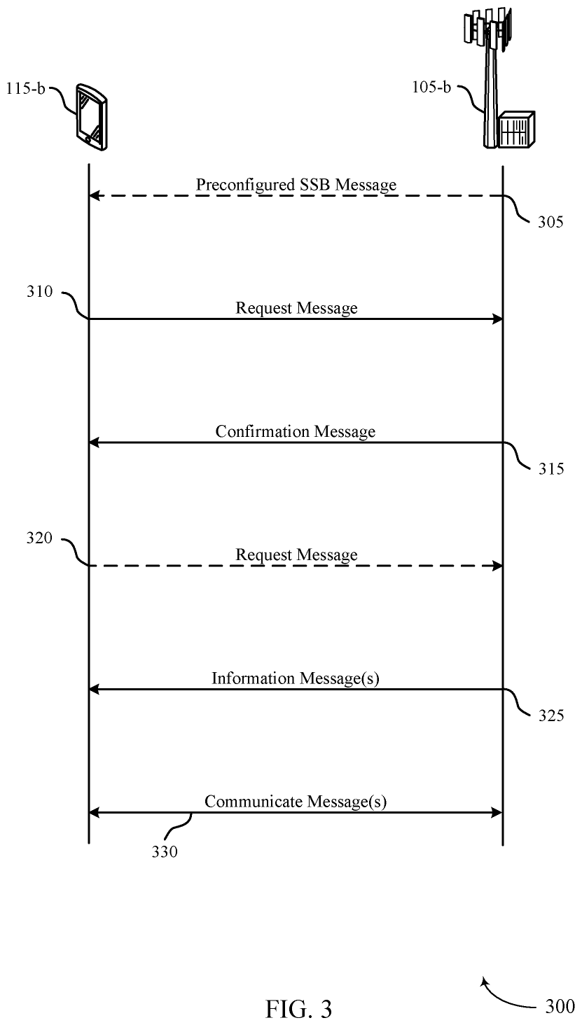

FIG. 3 shows an example of a process flow 300 that supports random access channel based requests for on-demand system information blocks in accordance with one or more aspects of the present disclosure. The process flow 300 includes a UE 115-b and a network entity 105-c, which may be examples of the corresponding devices as described with respect to FIGS. 1 and 2. In the following description of the process flow 300, the operations between the UE 115-b and the network entity 105-c may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may receive, from the network entity 105-b, a preconfigured SSB message. The preconfigured SSB may be an example of the preconfigured SSB (e.g., an “always on” SSB) as described with reference to FIG. 2. The preconfigured SSB may include an indication of a configuration for performing an on-demand first system information block procedure (e.g., an on-demand SIB1 procedure). Additionally or alternatively, the UE 115-b may receive the configuration from a cell (e.g., separate from the network entity 105-b). In some cases, the configuration may be preconfigured at the UE 115-b.

At 310, the UE 115-b may transmit, to the network entity 105-b, a first message (e.g., a request message) that indicates a request for an on-demand first system information block (e.g., a SIB1). In some cases, transmitting the first message may be based on the configuration for performing the on-demand first system information block procedure. Additionally or alternatively, the first message may indicate a request for an on-demand synchronization signal (e.g., an SSB). The UE 115-b may transmit the first message via a physical channel such as a physical random access channel, a physical uplink shared channel, or a physical uplink control channel, a similar physical channel, or any combination thereof. In some cases, the first message may be a RACH message in a RACH procedure (e.g., Msg1, Msg3, or msgA of a RACH procedure).

In some cases, the UE 115-b may receive signaling indicating a configuration for multiple monitoring occasions associated with receiving a set of preconfigured synchronization signals (e.g., “always on” SSBs). In such cases, time resources for receiving the on-demand synchronization signal may be non-overlapping with the multiple monitoring occasions. That is, the network entity 105-b may transmit the preconfigured synchronization signals in accordance with a periodicity irrespective of a request from the UE 115-b. In other words, the UE 115-b may receive the preconfigured (or “always on”) synchronization signals while the UE 115-b is in an idle mode or an inactive mode (e.g., RRC inactive mode) and may receive on-demand synchronization signals, on-demand first system information blocks, or both, irrespective of the periodicity associated with the preconfigured synchronization signals.

At 315, the UE 115-b may receive, from the network entity 105-b, in response to the first message, and via a physical channel (such as a PDSCH or a PDCCH), a second message. The second message may indicate for the UE 115-b to monitor for reception of the on-demand first system information block. In some cases, the second message may indicate a confirmation of successful reception of the request for the on-demand first system information block.

In some cases, the second message may include signaling that includes one or more synchronization signal block indices associated with one or more respective on-demand system information blocks, a transmission repetition periodicity for the one or more respective on-demand system information blocks, a time duration during which the UE is to monitor one or more physical channels (e.g., PDCCH), information related to cell access, or any combination thereof. The second message may be a RACH message of a RACH procedure (e.g., Msg2, Msg4, or msgB of a RACH procedure). For example, the second message may be an example of a random access response message. Alternatively, the second message may be a DCI message based on a cyclic redundancy check that is scrambled by a random access radio network temporary identifier or a temporary cell radio network temporary identifier. Thus, the UE may be configured with the time duration, during which the UE is to monitor the one or more physical channels, with the DCI message or a second DCI message. The DCI message (or the second DCI message) may schedule a physical channel (e.g., PDSCH) carrying the on-demand first system information block. Additionally or alternatively, the UE may be configured with the time duration with a repetition of a PDSCH message carrying a SIB1 (e.g., in an on-demand system information block). In some examples, the UE 115-b may receive the system information in one or more fields of the downlink control information message that are also used for a second set of signaling information. In some other examples, the UE 115-b may receive the system information in one or more fields of the downlink control information message that are reserved for indicating for the UE to monitor for reception of the on-demand first system information block, for indicating the system information, or both. In some cases, the system information may include one or more synchronization signal block indices associated with one or more respective on-demand synchronization signal blocks, a transmission repetition periodicity for the one or more respective on-demand synchronization signal blocks, or any combination thereof.

At 320, if the UE 115-b failed to receive the second message (e.g., the confirmation message, the UE 115-b may retransmit the first message (e.g., the request message). In some cases, the UE 115-b may periodically retransmit the first message until receiving the confirmation message. If the UE 115-b fails to receive the second message after a quantity of retransmissions, the UE may refrain from retransmitting the second message.

At 325, the UE 115-b may receive, based on the second message and via the physical channel, a third message that includes the on-demand first system information block. In some cases, receiving the third message may include receiving one or more messages. The one or more messages may include one or more on-demand first system information blocks, one or more synchronization signals (e.g., SSBs) or any combination thereof, based on the first message (e.g., the request message). For example, if the first message includes a request for a first system information block and a request for a synchronization signal, the UE 115-b may receive, from the network entity 105-b, a first system information block and an associated synchronization signal.

At 330, the UE 115-b may transition from an idle (or inactive) state to a connected state (e.g., an RRC connected state). In the connected state, the UE 115-b may communicate one or more messages with a network entity 105-b based on the third message. For example, the UE 115-b may communicate the one or more messages with the network entity 105-b based on the one or more on-demand first system information blocks, the one or more synchronization signals, or any combination thereof.

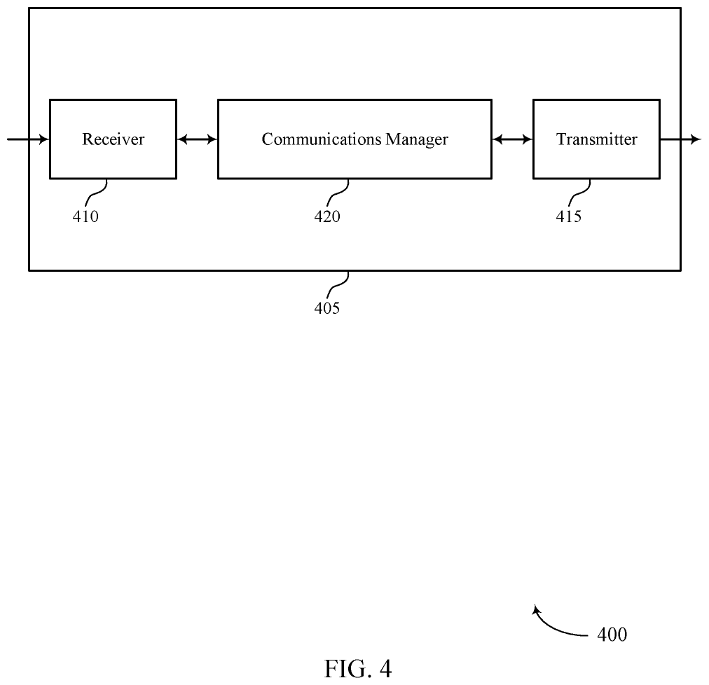

FIG. 4 shows a block diagram 400 of a device 405 that supports random access channel based requests for on-demand system information blocks in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to random access channel based requests for on-demand system information blocks). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to random access channel based requests for on-demand system information blocks). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of random access channel based requests for on-demand system information blocks as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a first message that indicates a request for an on-demand first system information block. The communications manager 420 is capable of, configured to, or operable to support a means for receiving, in response to the first message and via a physical channel, a second message indicating for the UE to monitor for reception of the on-demand first system information block. The communications manager 420 is capable of, configured to, or operable to support a means for receiving, based on the second message and via the physical channel, a third message that includes the on-demand first system information block. The communications manager 420 is capable of, configured to, or operable to support a means for communicating with a network entity based on the on-demand first system information block.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for random access channel based requests for on-demand system information blocks, which may result in reduced PDCCH search and access latency, power consumption, more efficient utilization of communication resources, among other advantages.

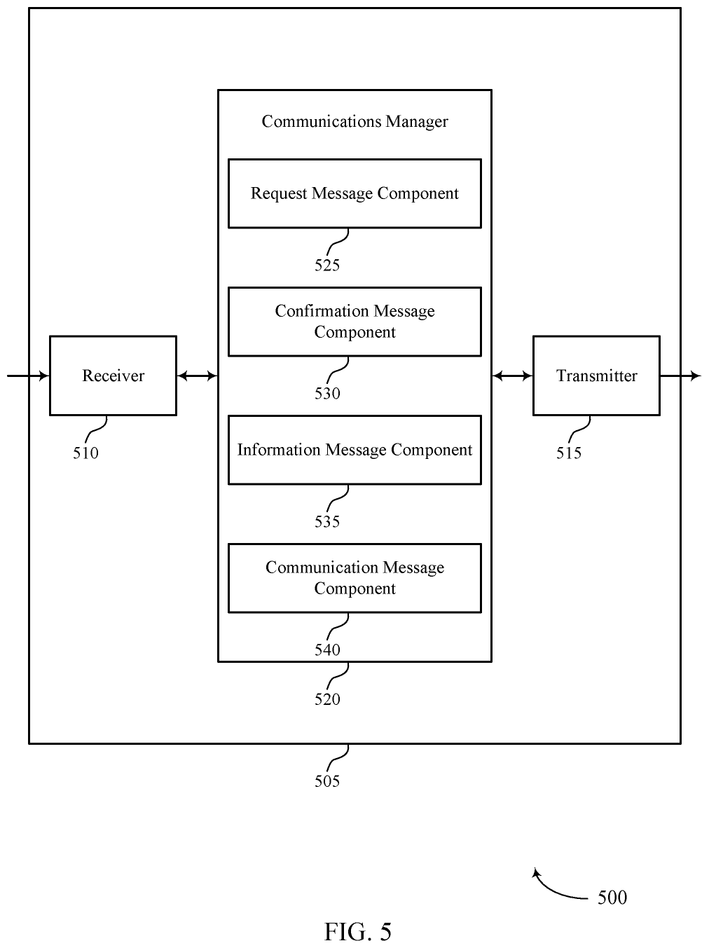

FIG. 5 shows a block diagram 500 of a device 505 that supports random access channel based requests for on-demand system information blocks in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to random access channel based requests for on-demand system information blocks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access channel based requests for on-demand system information blocks). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of random access channel based requests for on-demand system information blocks as described herein. For example, the communications manager 520 may include a request message component 525, a confirmation message component 530, an information message component 535, a communication message component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The request message component 525 is capable of, configured to, or operable to support a means for transmitting a first message that indicates a request for an on-demand first system information block. The confirmation message component 530 is capable of, configured to, or operable to support a means for receiving, in response to the first message and via a physical channel, a second message indicating for the UE to monitor for reception of the on-demand first system information block. The information message component 535 is capable of, configured to, or operable to support a means for receiving, based on the second message and via the physical channel, a third message that includes the on-demand first system information block. The communication message component 540 is capable of, configured to, or operable to support a means for communicating with a network entity based on the on-demand first system information block.

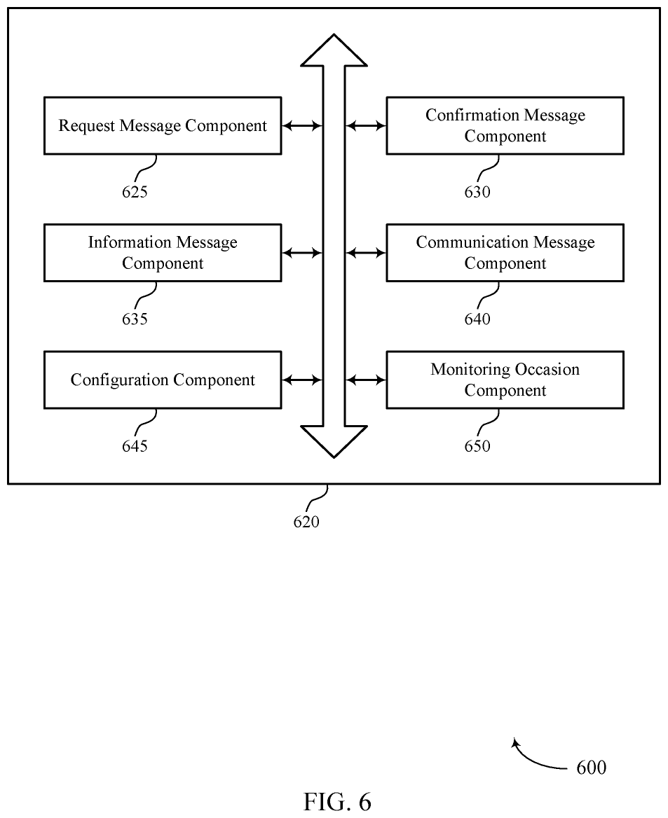

FIG. 6 shows a block diagram 600 of a communications manager 620 that supports random access channel based requests for on-demand system information blocks in accordance with one or more aspects of the present disclosure. The communications manager 620 may be an example of aspects of a communications manager 420, a communications manager 520, or both, as described herein. The communications manager 620, or various components thereof, may be an example of means for performing various aspects of random access channel based requests for on-demand system information blocks as described herein. For example, the communications manager 620 may include a request message component 625, a confirmation message component 630, an information message component 635, a communication message component 640, a configuration component 645, a monitoring occasion component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The request message component 625 is capable of, configured to, or operable to support a means for transmitting a first message that indicates a request for an on-demand first system information block. The confirmation message component 630 is capable of, configured to, or operable to support a means for receiving, in response to the first message and via a physical channel, a second message indicating for the UE to monitor for reception of the on-demand first system information block. The information message component 635 is capable of, configured to, or operable to support a means for receiving, based on the second message and via the physical channel, a third message that includes the on-demand first system information block. The communication message component 640 is capable of, configured to, or operable to support a means for communicating with a network entity based on the on-demand first system information block.

In some examples, the configuration component 645 is capable of, configured to, or operable to support a means for receiving signaling indicating a configuration for performing an on-demand first system information block procedure, where transmitting the first message is based on the configuration.

In some examples, to support receiving the second message, the confirmation message component 630 is capable of, configured to, or operable to support a means for receiving a confirmation of successful reception of the request for the on-demand first system information block.

In some examples, to support receiving the second message, the confirmation message component 630 is capable of, configured to, or operable to support a means for receiving signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

In some examples, the second message is a random access response message.

In some examples, the second message is a downlink control information message based on a cyclic redundancy check that is scrambled by a random access radio network temporary identifier.

In some examples, the signaling is received in one or more fields of the downlink control information message that are also used for a second set of signaling information.

In some examples, the signaling is received in one or more fields of the downlink control information message that are reserved for indicating for the UE to monitor for reception of the on-demand first system information block.

In some examples, to support receiving the system information, the confirmation message component 630 is capable of, configured to, or operable to support a means for receiving the signaling that includes one or more synchronization signal block indices associated with one or more respective on-demand synchronization signal blocks, a transmission repetition periodicity for the one or more respective on-demand synchronization signal blocks, or any combination thereof.

In some examples, to support communicating with the network entity, the communication message component 640 is capable of, configured to, or operable to support a means for transitioning from an idle state to a radio resource control connected state.

In some examples, the first message further indicates a request for an on-demand synchronization signal.

In some examples, the monitoring occasion component 650 is capable of, configured to, or operable to support a means for receiving signaling indicating a configuration for a set of multiple monitoring occasions associated with receiving a set of preconfigured synchronization signals, where time resources for receiving the on-demand synchronization signal are non-overlapping with the set of multiple monitoring occasions.

In some examples, to support transmitting the first message, the request message component 625 is capable of, configured to, or operable to support a means for transmitting the first message via a physical random access channel, a physical uplink shared channel, or a physical uplink control channel.

In some examples, the first message and the second message are random access channel messages in a random access channel procedure.

In some examples, the physical channel is a physical downlink shared channel or a physical downlink control channel.

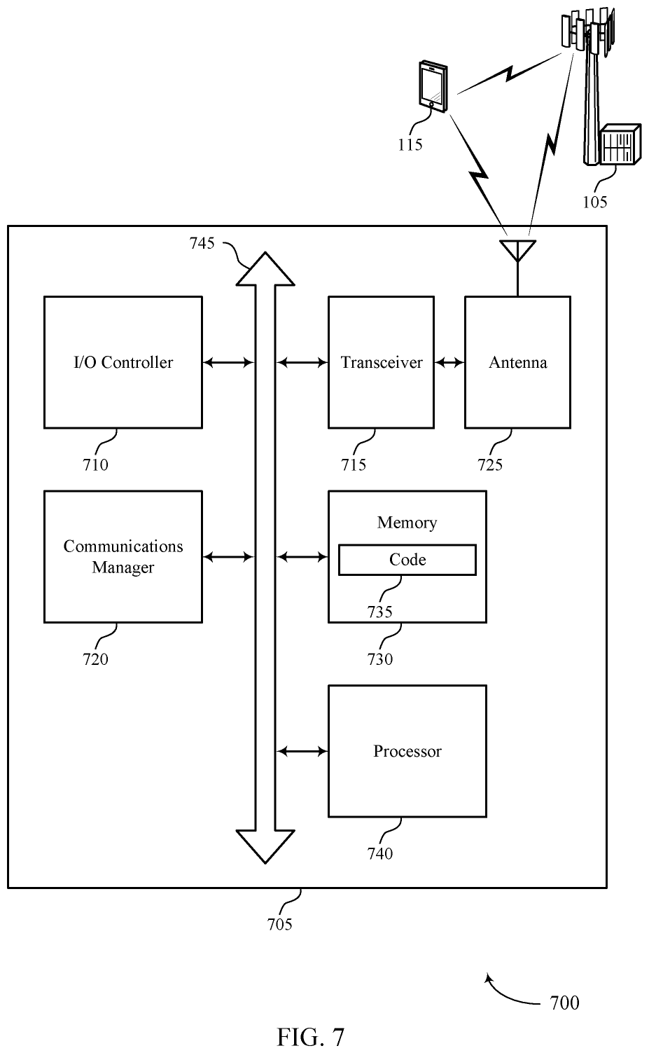

FIG. 7 shows a diagram of a system 700 including a device 705 that supports random access channel based requests for on-demand system information blocks in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting random access channel based requests for on-demand system information blocks). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a first message that indicates a request for an on-demand first system information block. The communications manager 720 is capable of, configured to, or operable to support a means for receiving, in response to the first message and via a physical channel, a second message indicating for the UE to monitor for reception of the on-demand first system information block. The communications manager 720 is capable of, configured to, or operable to support a means for receiving, based on the second message and via the physical channel, a third message that includes the on-demand first system information block. The communications manager 720 is capable of, configured to, or operable to support a means for communicating with a network entity based on the on-demand first system information block.

By including or configuring the communications manager 720 in accordance with examples as described herein, the device 705 may support techniques for random access channel based requests for on-demand system information blocks, which may result in reduced PDCCH search and access latency, improved communication reliability, reduced power consumption, more efficient utilization of communication resources, improved coordination between devices, longer battery life, improved utilization of processing capability, reduced network energy usage, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of random access channel based requests for on-demand system information blocks as described herein, or the at least one processor 740 and the at least one memory 730 may be otherwise configured to, individually or collectively, perform or support such operations.

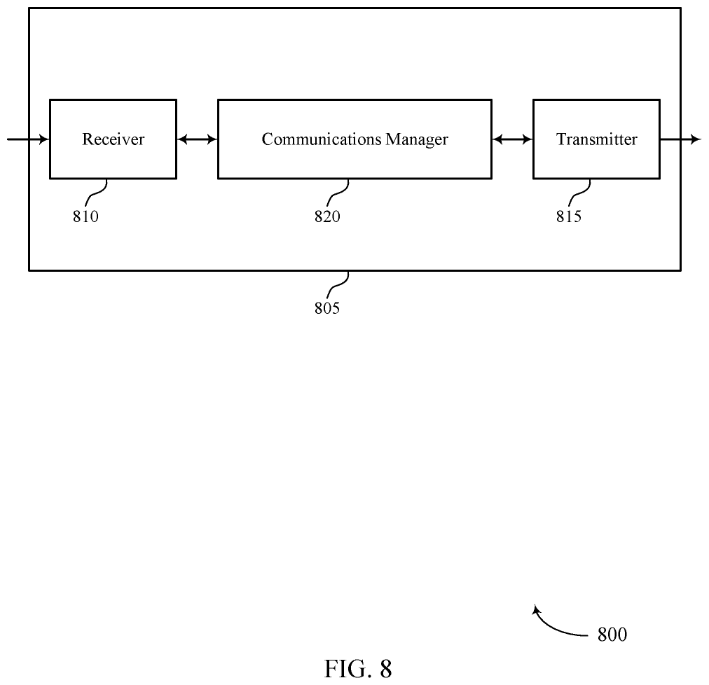

FIG. 8 shows a block diagram 800 of a device 805 that supports random access channel based requests for on-demand system information blocks in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of random access channel based requests for on-demand system information blocks as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining, from a UE, a first message that indicates a request for an on-demand first system information block. The communications manager 820 is capable of, configured to, or operable to support a means for outputting, in response to the first message and via a physical channel, a second message indicating for the UE to monitor for reception of the on-demand first system information block. The communications manager 820 is capable of, configured to, or operable to support a means for outputting, based on the second message and via the physical channel, a third message that includes the on-demand first system information block. The communications manager 820 is capable of, configured to, or operable to support a means for communicating with the UE based on the on-demand first system information block.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for random access channel based requests for on-demand system information blocks, which may result in reduced PDCCH search and access latency, power consumption, more efficient utilization of communication resources, among other advantages.

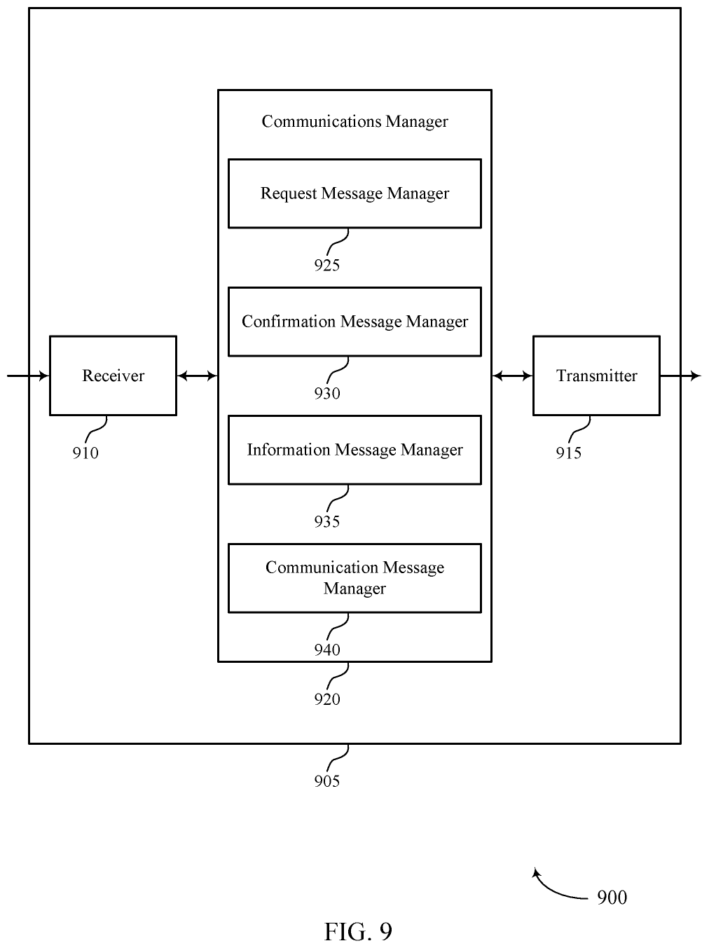

FIG. 9 shows a block diagram 900 of a device 905 that supports random access channel based requests for on-demand system information blocks in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of random access channel based requests for on-demand system information blocks as described herein. For example, the communications manager 920 may include a request message manager 925, a confirmation message manager 930, an information message manager 935, a communication message manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The request message manager 925 is capable of, configured to, or operable to support a means for obtaining, from a UE, a first message that indicates a request for an on-demand first system information block. The confirmation message manager 930 is capable of, configured to, or operable to support a means for outputting, in response to the first message and via a physical channel, a second message indicating for the UE to monitor for reception of the on-demand first system information block. The information message manager 935 is capable of, configured to, or operable to support a means for outputting, based on the second message and via the physical channel, a third message that includes the on-demand first system information block. The communication message manager 940 is capable of, configured to, or operable to support a means for communicating with the UE based on the on-demand first system information block.

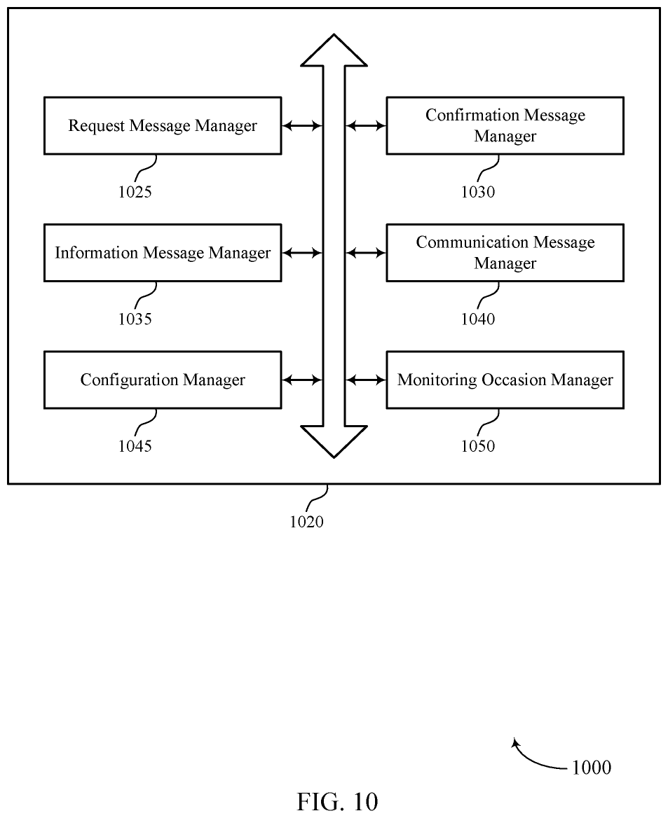

FIG. 10 shows a block diagram 1000 of a communications manager 1020 that supports random access channel based requests for on-demand system information blocks in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of random access channel based requests for on-demand system information blocks as described herein. For example, the communications manager 1020 may include a request message manager 1025, a confirmation message manager 1030, an information message manager 1035, a communication message manager 1040, a configuration manager 1045, a monitoring occasion manager 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The request message manager 1025 is capable of, configured to, or operable to support a means for obtaining, from a UE, a first message that indicates a request for an on-demand first system information block. The confirmation message manager 1030 is capable of, configured to, or operable to support a means for outputting, in response to the first message and via a physical channel, a second message indicating for the UE to monitor for reception of the on-demand first system information block. The information message manager 1035 is capable of, configured to, or operable to support a means for outputting, based on the second message and via the physical channel, a third message that includes the on-demand first system information block. The communication message manager 1040 is capable of, configured to, or operable to support a means for communicating with the UE based on the on-demand first system information block.

In some examples, the configuration manager 1045 is capable of, configured to, or operable to support a means for outputting signaling indicating a configuration for performing an on-demand first system information block procedure, where obtaining the first message is based on the configuration.

In some examples, to support outputting the second message, the confirmation message manager 1030 is capable of, configured to, or operable to support a means for outputting a confirmation of successful reception of the request for the on-demand first system information block.

In some examples, to support outputting the second message, the confirmation message manager 1030 is capable of, configured to, or operable to support a means for outputting signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

In some examples, the second message is a random access response message.

In some examples, the second message is a downlink control information message based on a cyclic redundancy check that is scrambled by a random access radio network temporary identifier.

In some examples, the signaling is output in one or more fields of the downlink control information message that are also used for a second set of signaling information.

In some examples, the signaling is output in one or more fields of the downlink control information message that are reserved for indicating for the UE to monitor for reception of the on-demand first system information block.

In some examples, to support outputting the system information, the confirmation message manager 1030 is capable of, configured to, or operable to support a means for outputting the signaling that includes one or more synchronization signal block indices associated with one or more respective on-demand synchronization signal blocks, a transmission repetition periodicity for the one or more respective on-demand synchronization signal blocks, or any combination thereof.

In some examples, to support communicating with the UE, the communication message manager 1040 is capable of, configured to, or operable to support a means for transitioning from an idle state to a radio resource control connected state.

In some examples, the first message further indicates a request for an on-demand synchronization signal.

In some examples, the monitoring occasion manager 1050 is capable of, configured to, or operable to support a means for outputting signaling indicating a configuration for a set of multiple monitoring occasions associated with receiving a set of preconfigured synchronization signals, where time resources for receiving the on-demand synchronization signal are non-overlapping with the set of multiple monitoring occasions.

In some examples, to support obtaining the first message, the request message manager 1025 is capable of, configured to, or operable to support a means for obtaining the first message via a physical random access channel, a physical uplink shared channel, or a physical uplink control channel.

In some examples, the first message and the second message are random access channel messages in a random access channel procedure.

In some examples, the physical channel is a physical downlink shared channel or a physical downlink control channel.

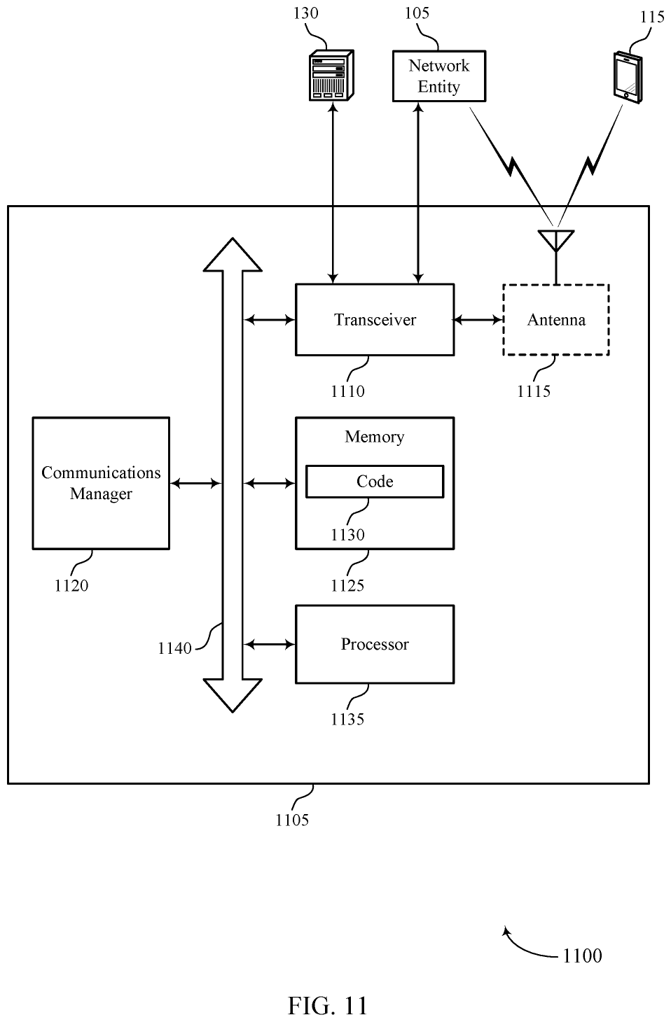

FIG. 11 shows a diagram of a system 1100 including a device 1105 that supports random access channel based requests for on-demand system information blocks in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting random access channel based requests for on-demand system information blocks). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network devices 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining, from a UE, a first message that indicates a request for an on-demand first system information block. The communications manager 1120 is capable of, configured to, or operable to support a means for outputting, in response to the first message and via a physical channel, a second message indicating for the UE to monitor for reception of the on-demand first system information block. The communications manager 1120 is capable of, configured to, or operable to support a means for outputting, based on the second message and via the physical channel, a third message that includes the on-demand first system information block. The communications manager 1120 is capable of, configured to, or operable to support a means for communicating with the UE based on the on-demand first system information block.

By including or configuring the communications manager 1120 in accordance with examples as described herein, the device 1105 may support techniques for random access channel based requests for on-demand system information blocks, which may result in reduced PDCCH search and access latency, improved communication reliability, reduced power consumption, more efficient utilization of communication resources, improved coordination between devices, longer battery life, improved utilization of processing capability, reduced network energy usage, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of random access channel based requests for on-demand system information blocks as described herein, or the at least one processor 1135 and the at least one memory 1125 may be otherwise configured to, individually or collectively, perform or support such operations.

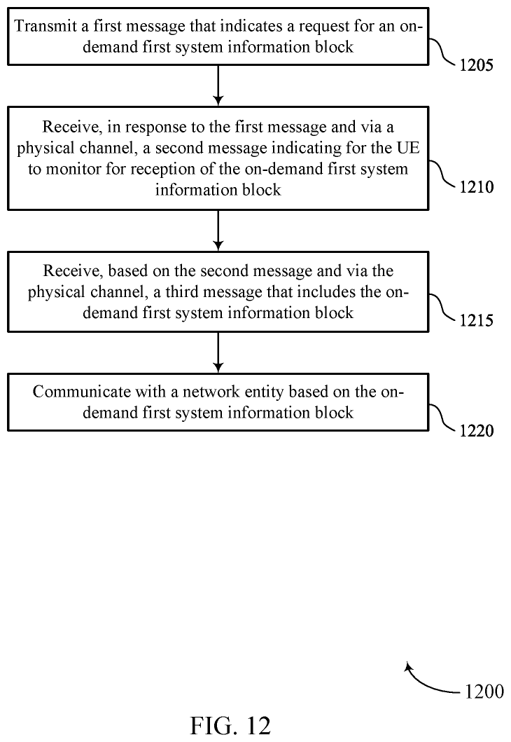

FIG. 12 shows a flowchart illustrating a method 1200 that supports random access channel based requests for on-demand system information blocks in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a first message that indicates a request for an on-demand first system information block. The operations of 1205 may be performed in accordance with examples as disclosed herein. In some examples, aspects of the operations of 1205 may be performed by a request message component 625 as described with reference to FIG. 6.

At 1210, the method may include receiving, in response to the first message and via a physical channel, a second message indicating for the UE to monitor for reception of the on-demand first system information block. The operations of 1210 may be performed in accordance with examples as disclosed herein. In some examples, aspects of the operations of 1210 may be performed by a confirmation message component 630 as described with reference to FIG. 6.

At 1215, the method may include receiving, based on the second message and via the physical channel, a third message that includes the on-demand first system information block. The operations of 1215 may be performed in accordance with examples as disclosed herein. In some examples, aspects of the operations of 1215 may be performed by an information message component 635 as described with reference to FIG. 6.

At 1220, the method may include communicating with a network entity based on the on-demand first system information block. The operations of 1220 may be performed in accordance with examples as disclosed herein. In some examples, aspects of the operations of 1220 may be performed by a communication message component 640 as described with reference to FIG. 6.

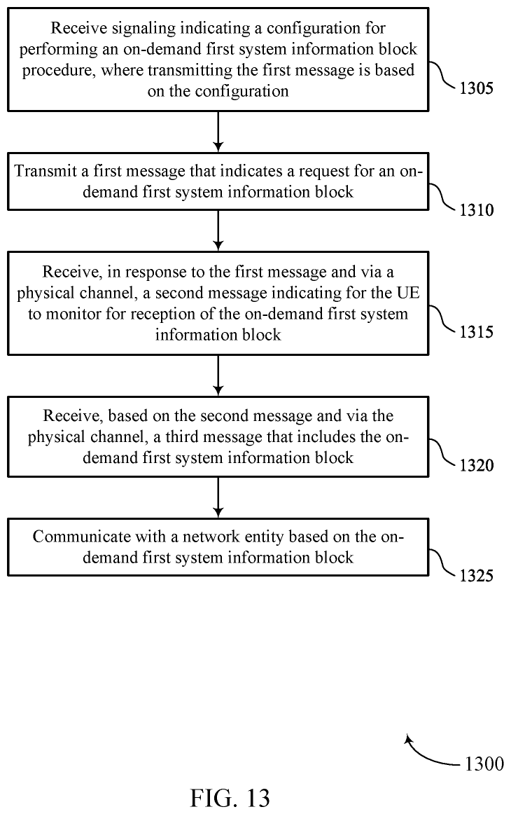

FIG. 13 shows a flowchart illustrating a method 1300 that supports random access channel based requests for on-demand system information blocks in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving signaling indicating a configuration for performing an on-demand first system information block procedure, where transmitting the first message is based on the configuration. The operations of 1305 may be performed in accordance with examples as disclosed herein. In some examples, aspects of the operations of 1305 may be performed by a configuration component 645 as described with reference to FIG. 6.

At 1310, the method may include transmitting a first message that indicates a request for an on-demand first system information block. The operations of 1310 may be performed in accordance with examples as disclosed herein. In some examples, aspects of the operations of 1310 may be performed by a request message component 625 as described with reference to FIG. 6.

At 1315, the method may include receiving, in response to the first message and via a physical channel, a second message indicating for the UE to monitor for reception of the on-demand first system information block. The operations of 1315 may be performed in accordance with examples as disclosed herein. In some examples, aspects of the operations of 1315 may be performed by a confirmation message component 630 as described with reference to FIG. 6.

At 1320, the method may include receiving, based on the second message and via the physical channel, a third message that includes the on-demand first system information block. The operations of 1320 may be performed in accordance with examples as disclosed herein. In some examples, aspects of the operations of 1320 may be performed by an information message component 635 as described with reference to FIG. 6.

At 1325, the method may include communicating with a network entity based on the on-demand first system information block. The operations of 1325 may be performed in accordance with examples as disclosed herein. In some examples, aspects of the operations of 1325 may be performed by a communication message component 640 as described with reference to FIG. 6.

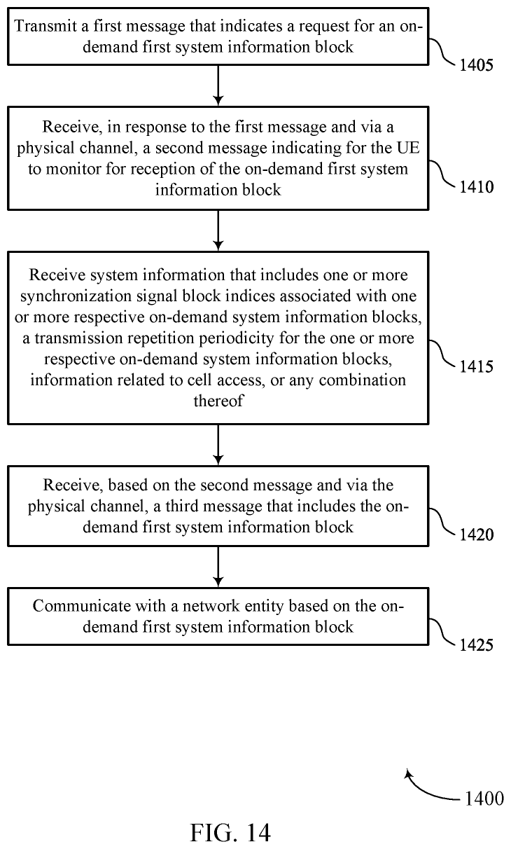

FIG. 14 shows a flowchart illustrating a method 1400 that supports random access channel based requests for on-demand system information blocks in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include transmitting a first message that indicates a request for an on-demand first system information block. The operations of 1405 may be performed in accordance with examples as disclosed herein. In some examples, aspects of the operations of 1405 may be performed by a request message component 625 as described with reference to FIG. 6.

At 1410, the method may include receiving, in response to the first message and via a physical channel, a second message indicating for the UE to monitor for reception of the on-demand first system information block. The operations of 1410 may be performed in accordance with examples as disclosed herein. In some examples, aspects of the operations of 1410 may be performed by a confirmation message component 630 as described with reference to FIG. 6.

At 1415, the method may include receiving signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof. The operations of 1415 may be performed in accordance with examples as disclosed herein. In some examples, aspects of the operations of 1415 may be performed by a confirmation message component 630 as described with reference to FIG. 6.

At 1420, the method may include receiving, based on the second message and via the physical channel, a third message that includes the on-demand first system information block. The operations of 1420 may be performed in accordance with examples as disclosed herein. In some examples, aspects of the operations of 1420 may be performed by an information message component 635 as described with reference to FIG. 6.

At 1425, the method may include communicating with a network entity based on the on-demand first system information block. The operations of 1425 may be performed in accordance with examples as disclosed herein. In some examples, aspects of the operations of 1425 may be performed by a communication message component 640 as described with reference to FIG. 6.

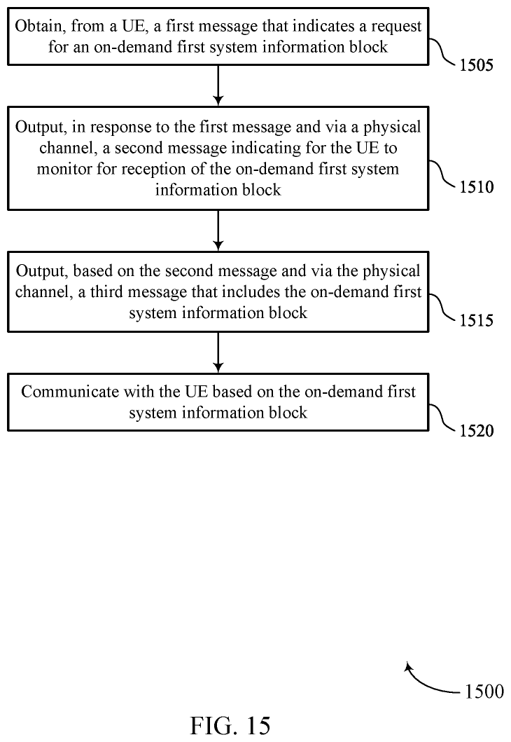

FIG. 15 shows a flowchart illustrating a method 1500 that supports random access channel based requests for on-demand system information blocks in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include obtaining, from a UE, a first message that indicates a request for an on-demand first system information block. The operations of 1505 may be performed in accordance with examples as disclosed herein. In some examples, aspects of the operations of 1505 may be performed by a request message manager 1025 as described with reference to FIG. 10.

At 1510, the method may include outputting, in response to the first message and via a physical channel, a second message indicating for the UE to monitor for reception of the on-demand first system information block. The operations of 1510 may be performed in accordance with examples as disclosed herein. In some examples, aspects of the operations of 1510 may be performed by a confirmation message manager 1030 as described with reference to FIG. 10.

At 1515, the method may include outputting, based on the second message and via the physical channel, a third message that includes the on-demand first system information block. The operations of 1515 may be performed in accordance with examples as disclosed herein. In some examples, aspects of the operations of 1515 may be performed by an information message manager 1035 as described with reference to FIG. 10.

At 1520, the method may include communicating with the UE based on the on-demand first system information block. The operations of 1520 may be performed in accordance with examples as disclosed herein. In some examples, aspects of the operations of 1520 may be performed by a communication message manager 1040 as described with reference to FIG. 10.

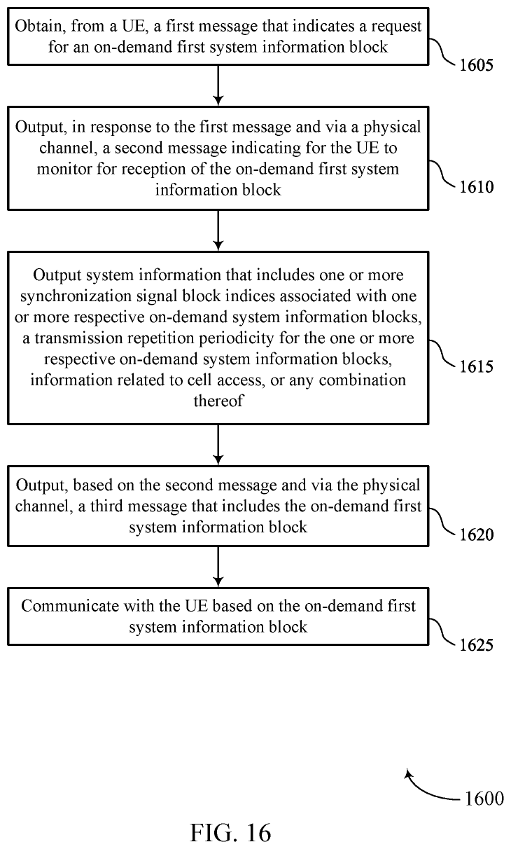

FIG. 16 shows a flowchart illustrating a method 1600 that supports random access channel based requests for on-demand system information blocks in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include obtaining, from a UE, a first message that indicates a request for an on-demand first system information block. The operations of 1605 may be performed in accordance with examples as disclosed herein. In some examples, aspects of the operations of 1605 may be performed by a request message manager 1025 as described with reference to FIG. 10.

At 1610, the method may include outputting, in response to the first message and via a physical channel, a second message indicating for the UE to monitor for reception of the on-demand first system information block. The operations of 1610 may be performed in accordance with examples as disclosed herein. In some examples, aspects of the operations of 1610 may be performed by a confirmation message manager 1030 as described with reference to FIG. 10.

At 1615, the method may include outputting signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof. The operations of 1615 may be performed in accordance with examples as disclosed herein. In some examples, aspects of the operations of 1615 may be performed by a confirmation message manager 1030 as described with reference to FIG. 10.

At 1620, the method may include outputting, based on the second message and via the physical channel, a third message that includes the on-demand first system information block. The operations of 1620 may be performed in accordance with examples as disclosed herein. In some examples, aspects of the operations of 1620 may be performed by an information message manager 1035 as described with reference to FIG. 10.

At 1625, the method may include communicating with the UE based on the on-demand first system information block. The operations of 1625 may be performed in accordance with examples as disclosed herein. In some examples, aspects of the operations of 1625 may be performed by a communication message manager 1040 as described with reference to FIG. 10.

The following provides an overview of aspects of the present disclosure:

Aspect 1: A method for wireless communications at a UE, comprising: transmitting a first message that indicates a request for an on-demand first system information block; receiving, in response to the first message and via a physical channel, a second message indicating for the UE to monitor for reception of the on-demand first system information block; receiving, based at least in part on the second message and via the physical channel, a third message that includes the on-demand first system information block; and communicating with a network entity based at least in part on the on-demand first system information block.

Aspect 2: The method of aspect 1, further comprising: receiving signaling indicating a configuration for performing an on-demand first system information block procedure, wherein transmitting the first message is based at least in part on the configuration.

Aspect 3: The method of any of aspects 1 through 2, wherein receiving the second message comprises: receiving a confirmation of successful reception of the request for the on-demand first system information block.

Aspect 4: The method of any of aspects 1 through 3, wherein receiving the second message comprises: receiving signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

Aspect 5: The method of aspect 4, wherein the second message is a random access response message.

Aspect 6: The method of any of aspects 4 through 5, wherein the second message is a downlink control information message based at least in part on a cyclic redundancy check that is scrambled by a random access radio network temporary identifier.

Aspect 7: The method of aspect 6, wherein the signaling is received in one or more fields of the downlink control information message that are also used for a second set of signaling information.

Aspect 8: The method of any of aspects 6 through 7, wherein the signaling is received in one or more fields of the downlink control information message that are reserved for indicating for the UE to monitor for reception of the on-demand first system information block.

Aspect 9: The method of any of aspects 4 through 8, wherein receiving the signaling further comprises: receiving the signaling that includes one or more synchronization signal block indices associated with one or more respective on-demand synchronization signal blocks, a transmission repetition periodicity for the one or more respective on-demand synchronization signal blocks, or any combination thereof.

Aspect 10: The method of any of aspects 1 through 9, wherein communicating with the network entity comprises: transitioning from an idle state to a radio resource control connected state.

Aspect 11: The method of any of aspects 1 through 10, wherein the first message further indicates a request for an on-demand synchronization signal.

Aspect 12: The method of aspect 11, further comprising: receiving signaling indicating a configuration for a plurality of monitoring occasions associated with receiving a set of preconfigured synchronization signals, wherein time resources for receiving the on-demand synchronization signal are non-overlapping with the plurality of monitoring occasions.

Aspect 13: The method of any of aspects 1 through 12, wherein transmitting the first message comprises: transmitting the first message via a physical random access channel, a physical uplink shared channel, or a physical uplink control channel.

Aspect 14: The method of any of aspects 1 through 13, wherein the first message and the second message are random access channel messages in a random access channel procedure.

Aspect 15: The method of any of aspects 1 through 14, wherein the physical channel is a physical downlink shared channel or a physical downlink control channel.

Aspect 16: A method for wireless communications at a network entity, comprising: obtaining, from a UE, a first message that indicates a request for an on-demand first system information block; outputting, in response to the first message and via a physical channel, a second message indicating for the UE to monitor for reception of the on-demand first system information block; outputting, based at least in part on the second message and via the physical channel, a third message that includes the on-demand first system information block; and communicating with the UE based at least in part on the on-demand first system information block.

Aspect 17: The method of aspect 16, further comprising: outputting signaling indicating a configuration for performing an on-demand first system information block procedure, wherein obtaining the first message is based at least in part on the configuration.

Aspect 18: The method of any of aspects 16 through 17, wherein outputting the second message comprises: outputting a confirmation of successful reception of the request for the on-demand first system information block.

Aspect 19: The method of any of aspects 16 through 18, wherein outputting the second message comprises: outputting signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

Aspect 20: The method of aspect 19, wherein the second message is a random access response message.

Aspect 21: The method of any of aspects 19 through 20, wherein the second message is a downlink control information message based at least in part on a cyclic redundancy check that is scrambled by a random access radio network temporary identifier.

Aspect 22: The method of aspect 21, wherein the signaling is output in one or more fields of the downlink control information message that are also used for a second set of signaling information.

Aspect 23: The method of any of aspects 21 through 22, wherein the signaling is output in one or more fields of the downlink control information message that are reserved for indicating for the UE to monitor for reception of the on-demand first system information block.

Aspect 24: The method of any of aspects 19 through 23, wherein outputting the signaling further comprises: outputting the signaling that includes one or more synchronization signal block indices associated with one or more respective on-demand synchronization signal blocks, a transmission repetition periodicity for the one or more respective on-demand synchronization signal blocks, or any combination thereof.

Aspect 25: The method of any of aspects 16 through 24, wherein communicating with the UE comprises: transitioning from an idle state to a radio resource control connected state.

Aspect 26: The method of any of aspects 16 through 25, wherein the first message further indicates a request for an on-demand synchronization signal.

Aspect 27: The method of aspect 26, further comprising: outputting signaling indicating a configuration for a plurality of monitoring occasions associated with receiving a set of preconfigured synchronization signals, wherein time resources for receiving the on-demand synchronization signal are non-overlapping with the plurality of monitoring occasions.

Aspect 28: The method of any of aspects 16 through 27, wherein obtaining the first message comprises: obtaining the first message via a physical random access channel, a physical uplink shared channel, or a physical uplink control channel.

Aspect 29: The method of any of aspects 16 through 28, wherein the first message and the second message are random access channel messages in a random access channel procedure.

Aspect 30: The method of any of aspects 16 through 29, wherein the physical channel is a physical downlink shared channel or a physical downlink control channel.

Aspect 31: A UE for wireless communications, comprising one or more memories storing processor-executable code, and one or more processors coupled with the one or more memories and individually or collectively operable to execute the code to cause the UE to perform a method of any of aspects 1 through 15.

Aspect 32: A UE for wireless communications, comprising at least one means for performing a method of any of aspects 1 through 15.

Aspect 33: A non-transitory computer-readable medium storing code for wireless communications, the code comprising instructions executable by one or more processors to perform a method of any of aspects 1 through 15.

Aspect 34: A network entity for wireless communications, comprising one or more memories storing processor-executable code, and one or more processors coupled with the one or more memories and individually or collectively operable to execute the code to cause the network entity to perform a method of any of aspects 16 through 30.

Aspect 35: A network entity for wireless communications, comprising at least one means for performing a method of any of aspects 16 through 30.

Aspect 36: A non-transitory computer-readable medium storing code for wireless communications, the code comprising instructions executable by one or more processors to perform a method of any of aspects 16 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first message that indicates a request for an on-demand first system information block;
receive, in response to the first message and via a physical channel, a second message indicating for the UE to monitor for reception of the on-demand first system information block;
receive, based at least in part on the second message and via the physical channel, a third message that includes the on-demand first system information block; and
communicate with a network entity based at least in part on the on-demand first system information block.

2. The UE of claim 1, wherein the one or more processors are individually or collectively further operable to execute the code to cause the UE to:
receive signaling indicating a configuration for performing an on-demand first system information block procedure, wherein transmitting the first message is based at least in part on the configuration.

3. The UE of claim 1, wherein, to receive the second message, the one or more processors are individually or collectively operable to execute the code to cause the UE to:
receive a confirmation of successful reception of the request for the on-demand first system information block.

4. The UE of claim 1, wherein, to receive the second message, the one or more processors are individually or collectively operable to execute the code to cause the UE to:
receive signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

5. The UE of claim 4, wherein the second message is a random access response message.

6. The UE of claim 4, wherein the second message is a downlink control information message based at least in part on a cyclic redundancy check that is scrambled by a random access radio network temporary identifier.

7. The UE of claim 6, wherein the signaling is received in one or more fields of the downlink control information message that are also used for a second set of signaling information.

8. The UE of claim 6, wherein the signaling is received in one or more fields of the downlink control information message that are reserved for indicating for the UE to monitor for reception of the on-demand first system information block.

9. The UE of claim 4, wherein, to receive the signaling, the one or more processors are individually or collectively further operable to execute the code to cause the UE to:
receive the signaling that includes one or more synchronization signal block indices associated with one or more respective on-demand synchronization signal blocks, a transmission repetition periodicity for the one or more respective on-demand synchronization signal blocks, or any combination thereof.

10. The UE of claim 1, wherein, to communicate with the network entity, the one or more processors are individually or collectively operable to execute the code to cause the UE to:
transition from an idle state to a radio resource control connected state.

11. The UE of claim 1, wherein the first message further indicates a request for an on-demand synchronization signal.

12. The UE of claim 11, wherein the one or more processors are individually or collectively further operable to execute the code to cause the UE to:
receive signaling indicating a configuration for a plurality of monitoring occasions associated with receiving a set of preconfigured synchronization signals, wherein time resources for receiving the on-demand synchronization signal are non-overlapping with the plurality of monitoring occasions.

13. The UE of claim 1, wherein, to transmit the first message, the one or more processors are individually or collectively operable to execute the code to cause the UE to:
transmit the first message via a physical random access channel, a physical uplink shared channel, or a physical uplink control channel.

14. The UE of claim 1, wherein the first message and the second message are random access channel messages in a random access channel procedure.

15. The UE of claim 1, wherein the physical channel is a physical downlink shared channel or a physical downlink control channel.

16. A network entity, comprising:
one or more memories storing processor-executable code; and
one or more processors coupled with the one or more memories and individually or collectively operable to execute the code to cause the network entity to:
obtain, from a user equipment (UE), a first message that indicates a request for an on-demand first system information block;
output, in response to the first message and via a physical channel, a second message indicating for the UE to monitor for reception of the on-demand first system information block;
output, based at least in part on the second message and via the physical channel, a third message that includes the on-demand first system information block; and
communicate with the UE based at least in part on the on-demand first system information block.

17. The network entity of claim 16, wherein the one or more processors are individually or collectively further operable to execute the code to cause the network entity to:
output signaling indicating a configuration for performing an on-demand first system information block procedure, wherein obtaining the first message is based at least in part on the configuration.

18. The network entity of claim 16, wherein, to output the second message, the one or more processors are individually or collectively operable to execute the code to cause the network entity to:
output a confirmation of successful reception of the request for the on-demand first system information block.

19. The network entity of claim 16, wherein, to output the second message, the one or more processors are individually or collectively operable to execute the code to cause the network entity to:
output signaling that includes one or more synchronization signal block indices associated with one or more respective on-demand system information blocks, a transmission repetition periodicity for the one or more respective on-demand system information blocks, a time duration during which the UE is to monitor one or more physical channels, information related to cell access, or any combination thereof.

20. The network entity of claim 19, wherein the second message is a random access response message.

21. The network entity of claim 19, wherein the second message is a downlink control information message based at least in part on a cyclic redundancy check that is scrambled by a random access radio network temporary identifier.

22. The network entity of claim 19, wherein, to output the signaling, the one or more processors are individually or collectively further operable to execute the code to cause the network entity to:
output the signaling that includes one or more synchronization signal block indices associated with one or more respective on-demand synchronization signal blocks, a transmission repetition periodicity for the one or more respective on-demand synchronization signal blocks, or any combination thereof.

23. The network entity of claim 16, wherein, to communicate with the UE, the one or more processors are individually or collectively operable to execute the code to cause the network entity to:
transition from an idle state to a radio resource control connected state.

24. The network entity of claim 16, wherein the first message further indicates a request for an on-demand synchronization signal.

25. The network entity of claim 24, wherein the one or more processors are individually or collectively further operable to execute the code to cause the network entity to:
output signaling indicating a configuration for a plurality of monitoring occasions associated with receiving a set of preconfigured synchronization signals, wherein time resources for receiving the on-demand synchronization signal are non-overlapping with the plurality of monitoring occasions.

26. The network entity of claim 16, wherein, to obtain the first message, the one or more processors are individually or collectively operable to execute the code to cause the network entity to:
obtain the first message via a physical random access channel, a physical uplink shared channel, or a physical uplink control channel.

27. A method for wireless communications at a user equipment (UE), comprising:
transmitting a first message that indicates a request for an on-demand first system information block;
receiving, in response to the first message and via a physical channel, a second message indicating for the UE to monitor for reception of the on-demand first system information block;
receiving, based at least in part on the second message and via the physical channel, a third message that includes the on-demand first system information block; and
communicating with a network entity based at least in part on the on-demand first system information block.

28. The method of claim 27, further comprising:
receiving signaling indicating a configuration for performing an on-demand first system information block procedure, wherein transmitting the first message is based at least in part on the configuration.

29. A method for wireless communications at a network entity, comprising:
obtaining, from a user equipment (UE), a first message that indicates a request for an on-demand first system information block;
outputting, in response to the first message and via a physical channel, a second message indicating for the UE to monitor for reception of the on-demand first system information block;
outputting, based at least in part on the second message and via the physical channel, a third message that includes the on-demand first system information block; and
communicating with the UE based at least in part on the on-demand first system information block.

30. The method of claim 29, further comprising:
outputting signaling indicating a configuration for performing an on-demand first system information block procedure, wherein obtaining the first message is based at least in part on the configuration.
